(19) United States
(12) Patent Application Publication
(10) Pub. No.: US 2005/0174362 A1
(43) Pub. Date: Aug. 11, 2005

(54) Method and system of zooming digital images

(76) Inventors: Chia-Hwa Lee, Taipei (TW); Shih-An Yang, Taipei (TW)

Correspondence Address: BIRCH STEWART KOLASCH & BIRCH, PO BOX 747, FALLS CHURCH, VA, 22040-0747, US

(21) Appl. No.: 10/775,164

(22) Filed: Feb. 11, 2004

(51) Int. Cl. G09G 5/00

(52) U.S. Cl. 345/660

(57) ABSTRACT

A method and system of zooming digital images is disclosed. By marking one or more coordinates with the index (for instance, cursor) in a display area, thus a position base can be defined. After a zooming ratio chosen by users or generating depending on the marked coordinates is decided, the display area renews with a zoomed image according to the position base and the zooming ratio. Comparing with continuously shifting the zoomed image for positioning, a lot of computing and hardware cost can be saved.

### BACKGROUND OF THE INVENTION

1. Field of the Invention

This present invention relates generally to a method and system of image display, and more particularly to a method and system of marking the position of image display and zooming ratio of image in accordance with the index or cursor.

2. Description of the Prior Art

In the field of image display, it usually requires displaying image information with a specific zooming ratio in a picture. This kind of application is usually bundled with some software or hardware, for instance image editing software or zooming digital images of digital camera.

In prior art, this kind of application usually takes the image position where image information is located at the center of display area as a position base, for instance pixels. After zooming the original image information with a specific zooming ratio, it renews a zoomed image according to the position base that is located at the center of display area. Since when the zooming ratio is changed, new image should be larger or smaller than the original display range; accordingly, users should shift the picture so that the image intended can be displayed in a display area. As a result, it will expend a lot of computing cost. First, in step 110, which is shown in FIG. 1, acquiring a zooming ratio and a position base, wherein acquiring method of the zooming ratio can be in many ways. For instance, acquiring by choosing one from default zooming ratios, increasing zooming ratio directly in proportion to a default zooming ratio or inputting by users. While the position base is generally acquired by the position in display information according to the central or upper left-hand corner of the display area (for instance, position of 1^{st} pixel in the display area). Next, in step 120, renewing a zoomed image in the display area according to the zooming ratio. And next, in step 130, displaying the zoomed image in the display area according to the position base. Finally, in step 140, shifting the zoomed image continuously until the display area displays parts of images intended.

As the method described above, it renews a zoomed image after the whole image information is zoomed in accordance with the zooming ratio. When the image information is very huge, some shortcomings will occur as the following. First, image is usually saved in a frame buffer before outputting that; thus, it requires a large frame buffer when using the method of prior art. Moreover, only part of the frame buffer is used for displaying in the display area, but otherwise frame buffer leaves unused. Besides, each time when image is shifted, it requires acquiring again part of the image for displaying in the display area from the frame buffer; accordingly it requires a lot of computing cost. Furthermore, we cannot anticipate the image display that is after shifting before it is shifted, so that it requires shifting continuously until it is appropriate. Each shift requires additional electric power and time, so if it is applied to portable devices (for instance, digital camera) taking account of costs and electric power, the cost of hardware and use of electric cell become uneconomical.

Evidently, the method of shifting image continuously after the image is zoomed in accordance with zooming ratio is uneconomical. Therefore, it requires providing portable devices with a more economical method or system.

### SUMMARY OF THE INVENTION

According to the requirements described above, one main objective of the present invention is to provide a method and system of zooming digital images according to a specific zooming ratio by a single coordinate. It's convenient to users when choosing parts of images in the display area arbitrarily and then renewing a zoomed image after zooming in or zooming out.

Besides, it is another objective of the present invention to provide a method and system of zooming image by a plurality of coordinates, wherein acquiring a position base and a zooming ratio in the way of selecting two coordinates by users or marking a range. It's convenient to users when choosing parts of images in the display area arbitrarily, and then renewing a zoomed image after zooming in or zooming out.

According to the objectives described above, the present invention provides a method of marking position and zooming images according to a single coordinate. It is used to mark a position base according to the index and conform to a zooming ratio; accordingly it renews a zoomed image in the display area according to the position base and the zooming ratio.

The present invention also provides a method of marking position and zooming images according to a plurality of coordinates. It is used to mark two coordinates by the index for acquiring a position base and a zooming ratio; accordingly the display area renews with a zoomed image according to the position base and the zooming ratio.

The present invention also provides a system of marking position and zooming images, comprising an image memory configured for saving image information, an interface means configured for producing a position base (which is a specific position of the image information) and a zooming ratio, an image processing unit configured for renewing a zoomed image in the display area according to the position base and the zooming ratio and a display means configured for displaying image in the display area.

Since it anticipates that the picture renews in original picture, so that it doesn't require shifting the picture continuously. Therefore, it saves a lot of computing cost and frame buffer cost.

### BRIEF DESCRIPTION OF THE DRAWING

The present invention can be best understood through the following description and accompanying drawings, wherein:

FIG. 1 schematically shows the flow chart of prior art;

FIG. 2 schematically shows the flow chart of one embodiment of the present invention;

FIG. 3 schematically shows the flow chart of one embodiment of the present invention; and

FIG. 4 schematically shows the block diagram of another embodiment of the present invention.

### DESCRIPTION OF THE PREFERRED EMBODIMENT

Some appropriate and preferred embodiments of the present invention will now be described in the following. It should be noted, however, that the embodiment is merely an example and can be variously modified without departing from the range of the present invention.

It is to be understood, however, that the drawings, which are not to scale, are designed for the purpose of illustration and not as a definition of the limits of the invention, for which reference should be made to the appended claims.

In prior art, when zooming images usually a picture is zoomed and shifted; therefore it requires a larger frame buffer and a lot of computing cost. As a result, main characteristic of the present invention is to mark the position base displayed actually in a picture first and then calculate a new picture by using the position base according to a zooming ratio (default or adjusted by users). Accordingly it renews a zoomed image in display area (for instance, LCD panel or OLED panel). Therefore, in the process of zooming images, it doesn't require shifting picture continuously so that it saves a lot of computing cost. Since it doesn't require shifting picture continuously and zooming the whole image information for shifting so that it only requires zooming part of the image needful to a new picture for producing a zoomed image; thus, it saves unnecessary frame buffer. Besides, it can also produce the pixels of new zoomed images in turn and then outputting that to the display area; thus it doesn't require a frame buffer.

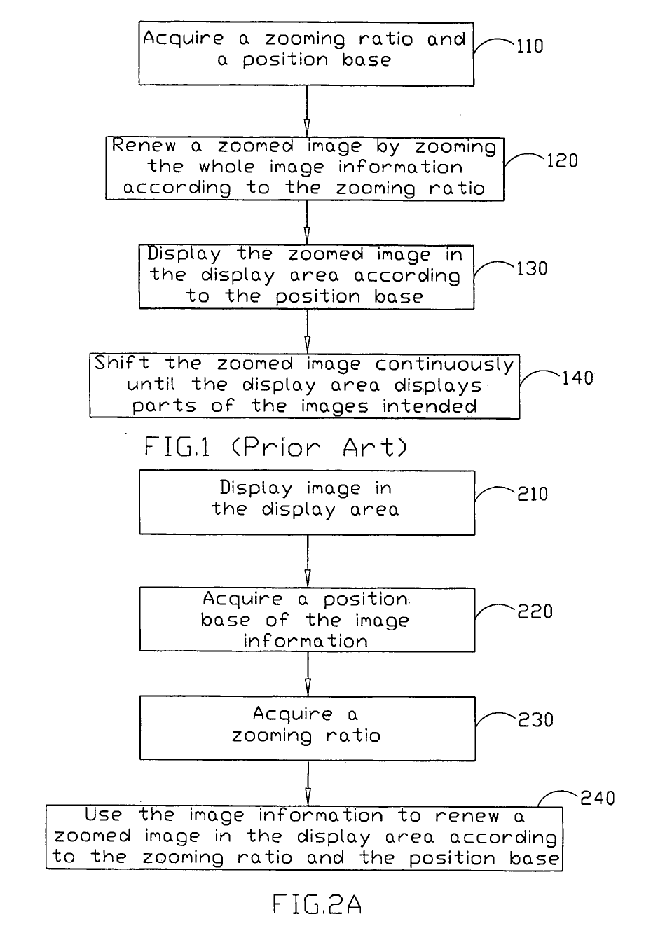

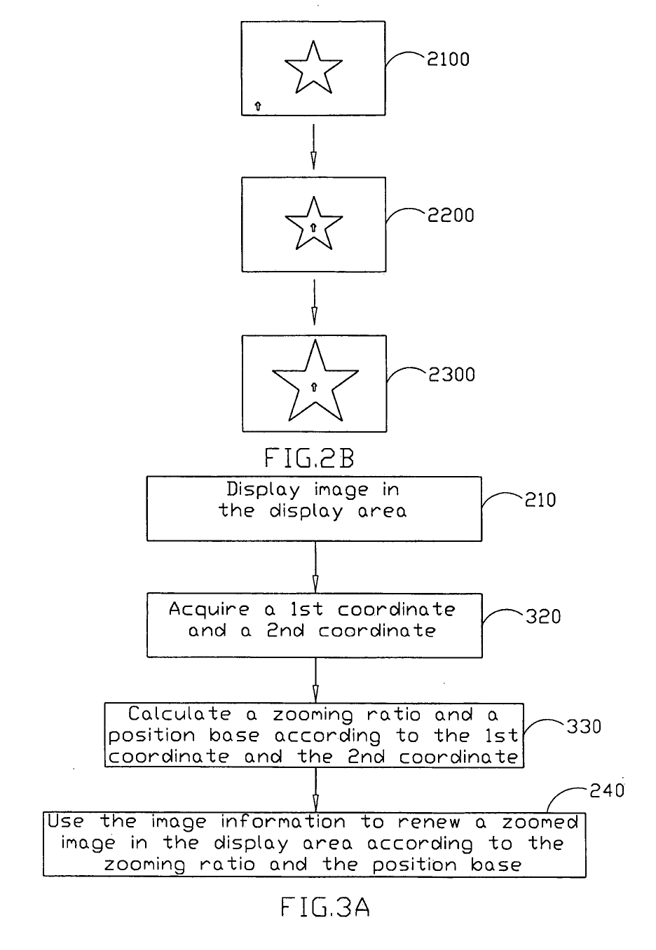

Therefore, one embodiment of the present invention is the method of zooming digital images with a single coordinate. FIG. 2A schematically shows the flow chart of one embodiment of the present invention. First in step 210, displaying image in the display area, wherein the image can be displayed according to format of the image information after acquiring the image information from digital images capture means. And the image information can be saved in different storage media (for instance, disk, flash card or memory) with different formats (for instance, pixels or files). Format of the image information and storage method of the present invention is not restricted. Besides, the image displayed in the display area can be presented merely with part of the captured image information or be presented with the whole image information. The range presented by the captured image information in the display area of the present invention is not restricted. The block 2100 in FIG. 2B schematically shows the diagram according to step 210.

Next, in step 220, acquiring a position base of the image information, wherein the position base is acquired according to the image information relative to a coordinate of the display area. In other words, taking the relative position of the coordinate in the image information presented in the display area as the position base. For instance, shifting the index (for instance, cursor) to the coordinate and then acquiring the position base; otherwise, inputting coordinate by users for acquiring the coordinate of the position base. The coordinate of the position base is the relative position in the image information to the coordinate; in other words, finding which is used in the image information for displaying in the coordinate, wherein the relative position can be a relative coordinate or a position of pixels. Acquiring method of the position base and representation method of the relative position of the present invention is not restricted. Besides, in step 220, acquiring a coordinate of central position of the display area in the meanwhile so as to be a reference coordinate point when renewing a zoomed image. The block 2200 in FIG. 2B is the diagram of step 220.

In the following, in step 220, acquiring a position base according to the relative position of the cursor location, and then acquiring a zooming ratio according to step 230. Acquiring method of the zooming ratio can be in many ways, for instance acquiring by choosing one from default zooming ratios, increasing zooming ratio in proportion to a default zooming ratio or inputting directly by users; thus, acquiring method of the zooming ratio of the present invention is not restricted.

Finally, as is shown in step 240, using the image information to renew a zoomed image in the display area according to the position base and the zooming ratio; otherwise, referring to coordinate of the central position and then renewing a zoomed image in the display area. And image display is to take the position base of the cursor location as a marked point, wherein the marked point can be any specific position in the display area. For instance, the specific position can be center of the display area, one of four corners of the display area (i.e. upper left-hand, upper right-hand, lower left-hand and lower right-hand) or other position, which is not restricted in the present invention. Next, the display area renews with a zoomed image according to the zooming ratio. Besides, the renewed image can be zooming in and zooming out according to the default zooming ratio or increasing (decreasing) the zooming ratio in proportion to the default zooming ratio directly. Moreover, size of the zoomed image can merely conform to the display area (i.e. merely using part of image information for renewing an image) and it can exceed range of the display area (i.e. using the whole image information for renewing an image). It can also refer to coordinate of the central position and then renewing a zoomed image in the display area. And size of the image is not restricted in the present invention. The former method can save cost of frame buffer and it even doesn't require frame buffer while renewing image in the display area directly. And the latter method can save time of image shifting of users while expending a lot of computing cost (for instance, electric power); thus it requires a large frame buffer. The block 2300 in FIG. 2B is the diagram of result after processing according to step 240. Accordingly, the embodiment not only comprises the function of image shift in prior art, but also makes choosing of images more convenient, time-saving and effort-saving to users.

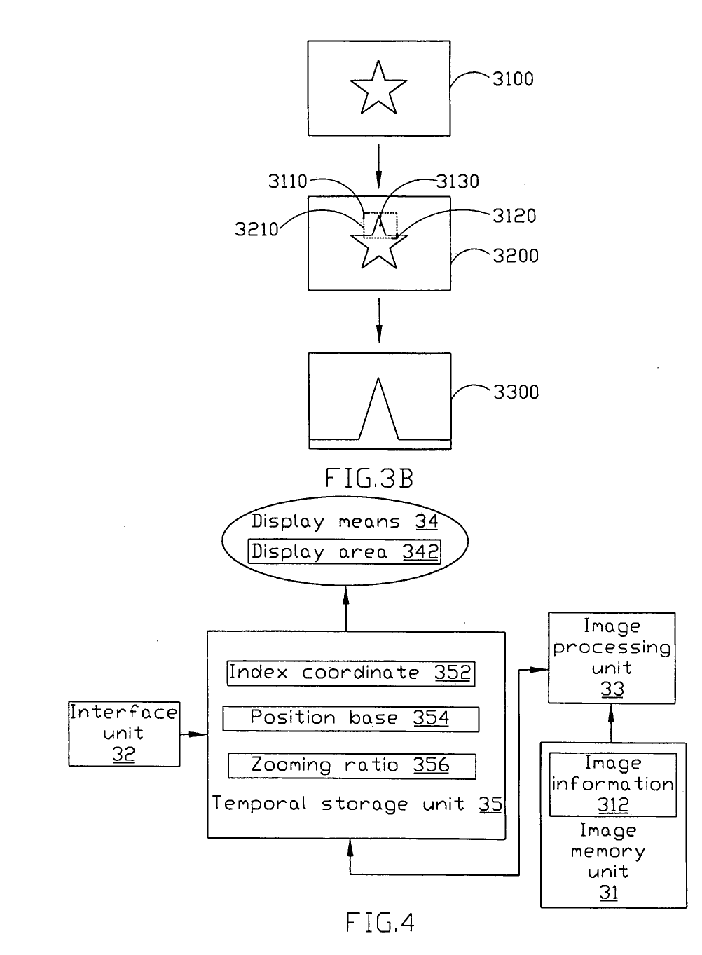

It is another embodiment of the present invention to provide a method of zooming image by a plurality of coordinates, and FIG. 3A schematically shows the flow chart of this embodiment. The difference between this embodiment and previous embodiment is that step 220 and step 230 in FIG. 2A is replaced respectively by step 320 and step 330 of this embodiment. In step 320, acquiring a 1^{st} coordinate 3310 (shown in FIG. 3B) and a 2^{nd} coordinate (shown in FIG. 3B). Acquiring method of the 1^{st} coordinate and the 2^{nd} coordinate can be inputted by users or shifting a cursor presented in the display area in sequence to position of the 1^{st} coordinate and the 2^{nd} coordinate by users for acquiring range or area of a coordinate.

Acquiring method of the 1^{st} coordinate and the 2^{nd} coordinate described above can be treated as marking a range of the display area or acquiring the 1^{st} coordinate and the 2^{nd} coordinate by marking a range of the display area. For instance, using the way marking a rectangle in the display area, which is as shown in 3210 of FIG. 3B. First, controlling the index marked at the 1^{st} coordinate 3110. Next, in the meantime of shifting the index, displaying a rectangular frame line 3210 taking the 1^{st} coordinate and location of the index as two endpoints of diagonal line in the display area and it is used for displaying the marked range. Otherwise, directly controlling the index to mark the 1^{st} coordinate 3110 and the 2^{nd} coordinate 3120 respectively in sequence and then producing the rectangular frame line 3210 taking the two coordinates as two endpoints of diagonal line. Similarly, the marked range is not restricted to rectangle only. It can also be a circle, which is produced by taking the 1^{st} coordinate and the 2^{nd} coordinate as two endpoints of diameter. And it can also be an ellipse, which is produced by taking the coordinate and the 2^{nd} coordinate as the major axis and the minor axis according to aspect ratio of the display area.

In the following, in step 330, calculating a zooming ratio and a position base according to size of the marked range by the 1^{st} coordinate 3110 and the 2^{nd} coordinate 3120. The position base can be acquired by choosing one between the 1^{st} coordinate and the 2^{nd} coordinate or central point 3130 (which is as shown in FIG. 3B) of the marked range by the two coordinates. And the zooming ratio can be acquired by the ratio according to the perpendicular width of the display area relative to the perpendicular distance between the 1^{st} coordinate and the 2^{nd} coordinate. Otherwise, it can be acquired by the ratio according to the horizontal width of the display area relative to the horizontal distance between the 1^{st} coordinate and the 2^{nd} coordinate.

And finally, as is described in step 240, using the image information to renew a zoomed image according to the position base and the zooming ratio. And detail of this embodiment is similar with the previous one; therefore it is not included in the following description.

According to the method disclosed above, it is another embodiment of the present invention to provide a system of zooming digital images, which is as shown in FIG. 4. And it comprises an image memory unit 31, an interface unit 32, an image processing unit 33, a display unit 34 and a temporal storage unit 35, wherein the image memory unit 31 is configured for recording image information 312. The image is produced according to step 210 described above. It is produced by the image processing unit 33 according to the image information 312 and then being displayed by the display unit 34, wherein the image produced can be saved in the temporal storage unit 35. Thus, the temporal storage unit 35 comprises a frame buffer for saving images and providing the display unit 34 for displaying.

Besides, the image processing unit 33 further comprises adding an index coordinate 352 in images. A coordinate position is produced relatively to location of the index and data of the coordinate can be saved in the temporal storage unit 35. In the meanwhile, it can also change the index coordinate 352 by the interface unit 32 for controlling location of the index, wherein the index coordinate 352 can be defined as the position that the index displayed in the display area 342. Otherwise, it can be defined as location of the index that part of the image information 312 displayed in the display area 342. For instance, position of a pixel in the image information 312 and position of the pixel is displayed in location of the index.

Besides, the interface unit 32 is further used to produce a position base 354 and a zooming ratio 356 according to step 220 and step 230 described above, wherein the position base 354 is a specific position in the image information 312. Acquiring method of the position base can be inputting coordinate by users for acquiring the coordinate of position base or shifting the index to the specific position and then acquiring the position base according to the index coordinate 352. It can also be another way for acquiring the specific position in image information 312 according to coordinate. And the position base 354 and the zooming ratio 356 can be saved in the temporal storage unit 35; thus the temporal storage unit 35 comprises a plurality of temporal storages, configured for saving the index coordinate 352, the position base 354 and the zooming ratio 356 described above.

Moreover, the interface unit 32 can acquire a 1^{st} coordinate 3110 and a 2^{nd} coordinate 3120 according to step 320 and step 330 described above and acquire the position base 354 and the zooming ratio 356 according to the two coordinates. Thus, the interface unit 32 further comprises an option, configured for choosing acquiring method of the zooming ratio 356 (for instance, to input by users, to choose one from default zooming ratios 356 or to acquire according to the 1^{st} coordinate and the 2^{nd} coordinate). It is therefore that the image processing unit 33 uses the image information 312 to renew a zoomed image in the display area 342 according to the position base 354 and the zooming ratio 356, which is as shown in step 240 described above. And detail of this embodiment is similar with the previous one; therefore it is not included in the following description.

The present invention can be applied to the system of position and display, as regards display of index is not the essential condition. For instance, the position base described above or coordinate can be acquired by touch screen when applying to the system of touch screen. In the system of touch screen, the index can be displayed in screen or not displayed in screen. Besides, the present invention can also be applied to portable devices, such as digital camera or mobile telephone.

While this invention has been described with reference to illustrative embodiments, this description does not intend or construe in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method of zooming digital images by a single coordinate, comprising:
displaying an image in a display area, wherein said image being displayed according to an image information;
acquiring a position base of said image information, wherein said position base being acquired according to said image information relative to a coordinate of said display area;
acquiring a zooming ratio; and
using said image information to renew a zoomed image in said display area according to said zooming ratio and said position base.

2. The method according to claim 1, wherein said coordinate is acquired by shifting an index displayed in said display area to said coordinate and therefore position of said index is said coordinate.

3. The method according to claim 1, wherein said index is a cursor.

4. The method according to claim 1, wherein said zooming ratio is acquired by choosing one from a plurality of default zooming ratios.

5. The method according to claim 1, wherein said zooming ratio is acquired by manual input.

6. The method according to claim 1, wherein said zoomed image is renewed directly in said display area according to said position base and said zooming ratio.

7. The method according to claim 1, wherein coordinate of central position of said display area is further acquired when acquiring a position base of said image information.

8. The method according to claim 7, wherein said zoomed image is renewed in central position of said display area according to said position base, said zooming ratio and coordinate of said central position.

9. The method according to claim 1, wherein said display area comprises four corners, upper left-hand, upper right-hand, lower left-hand and lower right-hand, and said zoomed image is renewed in one corner of said display area according to said position base and said zooming ratio.

10. The method according to claim 1, wherein said zoomed image is zoomed in according to said zooming ratio.

11. The method according to claim 1, wherein said zoomed image is zoomed out according to said zooming ratio.

12. The method according to claim 6, wherein size of said zooming ratio conforms to said display area when said zoomed image is displayed directly.

13. A method of zooming digital images by a plurality of coordinates, comprising:
displaying an image in a display area, wherein said image being displayed according to an image information;
acquiring a 1^{st} coordinate of said image information;
acquiring a 2^{nd} coordinate of said image information;
acquiring a position base relative to a zoomed image of said 1^{st} coordinate and said 2^{nd} coordinate, wherein said position base being acquired according to said 1^{st} coordinate and said 2^{nd} coordinate;
calculating a zooming ratio; and
using said image information to renew said zoomed image in said display area according to said zooming ratio and said position base.

14. The method according to claim 13, wherein coordinate of central position of said display area is further acquired when acquiring said position base.

15. The method according to claim 13, wherein a relative coordinate is acquired by shifting an index displayed in said display area respectively to said 1^{st} coordinate and said 2^{nd} coordinate and therefore position of said index is said relative coordinate.

16. The method according to claim 13, wherein said zooming ratio is acquired by a ratio of perpendicular width of said display area relative to perpendicular distance between said 1^{st} coordinate and 2^{nd} coordinate.

17. The method according to claim 13, wherein said zooming ratio is acquired by a ratio of horizontal width of said display area relative to horizontal distance between said 1^{st} coordinate and 2^{nd} coordinate.

18. The method according to claim 13, wherein said position base is taking a central point between position of said 1^{st} coordinate and position of said 2^{nd} coordinate as said position base, then renewing a zoomed image in central position of said display area according to said central point of said position base and coordinate of said central position.

19. The method according to claim 13, wherein said display area comprises four corners, upper left-hand, upper right-hand, lower left-hand and lower right-hand, and said image information is taking said 1^{st} coordinate as said position base, then said zoomed image is renewed in one corner of said display area according to said position base and said zooming ratio.

20. The method according to claim 13, wherein said zoomed image is zoomed in according to said zooming ratio.

21. The method according to claim 13, wherein said zoomed image is zoomed out according to said zooming ratio.

22. The method according to claim 13, wherein size of said zoomed image conforms to said display area.

23. A system of zooming digital images, comprising:
an image memory unit, configured for saving an image information;
an interface unit, configured for producing a position and a zooming ratio, wherein said position base being a specific position in said image information;
an image processing unit, configured for using said image information to renew an image displayed in said display area according to said zooming ratio and said position base; and
a display unit, configured for displaying said image in said image area.

24. The method according to claim 23, further comprising a temporal storage unit configured for saving said position base, said zooming ratio and said image.

25. The method according to claim 23, wherein said interface unit further comprises an index and said index is used to control position of said index by said interface unit, and position of said index displayed in said display area is relative to an index coordinate.

26. The method according to claim 23, wherein said position base is acquired according to said index coordinate when said index is shifted to a specific position.

27. The method according to claim 23, wherein said zooming ratio is acquired by choosing one from a plurality of default zooming ratios.

28. The method according to claim 23, wherein said zooming ratio is manually inputted.

29. The method according to claim 23, wherein said zooming ratio is produced directly according to a 1^{st} coordinate and a 2^{nd} coordinate of said display area.

30. The method according to claim 29, wherein said 1^{st} coordinate and said 2^{nd} coordinate is acquired by coordinate of said index after shifting said index to two specific positions in sequence.

31. The method according to claim 29, wherein said position base is one between said 1^{st} coordinate and said 2^{nd} coordinate.

32. The method according to claim 29, wherein said zooming ratio is acquired by a ratio of horizontal width of said display area relative to horizontal distance between said 1^{st} coordinate and 2^{nd} coordinate.

33. The method according to claim 29, wherein said zooming ratio is acquired by a ratio of perpendicular width of said display area relative to perpendicular distance between said 1^{st} coordinate and 2^{nd} coordinate.

34. The method according to claim 29, wherein said position base is taking a central point between position of said 1^{st} coordinate and position of said 2^{nd} coordinate as said position base, then renewing a zoomed image in central position of said display area according to said central point of said position base and coordinate of said central position.

35. The method according to claim 29, wherein said interface unit further comprises providing an option configured for choosing acquiring method of said zooming ratio.

36. The method according to claim 23, wherein said zoomed image is renewed according to central position of said display area.

37. The method according to claim 23, wherein said display area comprises four corners, upper left-hand, upper right-hand, lower left-hand and lower right-hand, and said image information is taking said 1^{st} coordinate as said position base, then said zoomed image is renewed in one corner of said display area according to said position base and said zooming ratio.

38. The method according to claim 23, wherein said zoomed image is zoomed in according to said zooming ratio.

39. The method according to claim 23, wherein said zoomed image is zoomed out according to said zooming ratio.
